(19) United States
(12) Patent Application Publication
(10) Pub. No.: US 2026/0200260 A1
(43) Pub. Date: Jul. 16, 2026

(54) PERSONALIZATION MODULE FOR SECURITY DOCUMENTS

(71) Applicant: SURYS, Bussy St Georges (FR)

(72) Inventors: Kurt BORMET, Bussy St Georges (FR); Sebastian HINRICHS, Bussy St Georges (FR); Michael BIERMANN, Bussy St Georges (FR)

(73) Assignee: SURYS, Bussy St Georges (FR)

(21) Appl. No.: 19/141,110

(22) PCT Filed: Dec. 15, 2023
(86) PCT No.: PCT/EP2023/086049

§ 371 Date: Jun. 19, 2025

(30) Foreign Application Priority Data
Dec. 20, 2022 (EP) 22215166.4

(51) Int. Cl. B42D 25/435

(52) U.S. Cl. CPC B42D 25/435

(57) ABSTRACT

A personalization module, for personalization of a security document having a marking area for marking a two-image element MLI or CLI through an array of lenticular. The personalization module includes: a laser marking module, configured to mark within a marking zone, and having a laser head configured to emit a laser beam, and a laser scanner equipped with movable mirrors to deflect the laser beam towards the document. The personalization module further includes an optical prism, configured to refract the laser beam from the laser scanner mirrors to the lenticular lenses. One side of the prism enabling marking a first image element of the MLI or the CLI. The other side of the prism enabling marking a second image element of the MLI or the CLI.

The present invention relates to personalization modules, for personalization of security documents/booklets, where in particular documents/booklets are identity documents.

Identity document shall be interpreted as a document containing information relating to its holder, that can be issued by an authority/government such as for instance a passport or an identity card etc., or a non-official document that can be issued by private firms, such as for instance season tickets, subscription cards, etc.

For the sake of brevity, identity documents, whether in the form of booklets of polycarbonate cards, will be described here after as “documents”. Documents are not limited to those comprising polycarbonate but encompass those comprising any engravable materials.

Documents are flat and comprise a multiple laser image (MLI) or a changeable laser image (CLI), which are secure elements especially in the market of governmental documents, but not limited to.

MLI or CLI is called flip image, or without distinction tilt image. MLI or CLI are visible of with a lenticular array, having a main direction of orientation. Usually MLI are visible when flipping, tilting or rotating the document around an «horizontal » direction of orientation parallel to the reading direction; where CLI are visible around a «vertical » direction of orientation.

MLI or CLI are typically used for personalization purpose of the document. They are produced and visible through an array of fine cylindrical lenticular lenses, also called lenticular screen, with a radius as little as a few microns, which are disposed on a flat support, and which enable an easy-to-check visible security feature where two pieces of information can be seen depending on the viewing angle.

Typically, the cylindrical lenticular lenses of MLI or CLI are orientated along a main direction of orientation. The main direction of orientation of the lenticular lenses for the MLI is perpendicular to the main direction of orientation of the lenticular lenses for the CLI.

A flip image is written on a document with help of a lenticular screen and can be seen with help of said lenticular screen on said flat support. A flip image in fact shows two different contents or two different images, each content or image seen depending on the viewing angle. A flip image can be a set of two image elements such as e.g. a portrait, a logo, a symbol, a number, a chain of characters, etc.

Typically for a document according to the present invention, a flip image relates to the holder of the document. Accordingly, a flip image is used for personalization and securitization of the document.

Today, a document usually comprises either MLI or CLI, but not both.

During the personalization phase, each MLI or CLI is a laser-marked, laser-engraved, with a flipping set of two image elements, which become unalterable after marking, making it almost impossible to forge the document at a later stage.

The present invention relates precisely to a device for writing a flip image on a document.

In this context, it is known document EP2050574, which relates to a device for writing a tilt image structure on a base body, comprising a set of deflection mirrors.

According to EP2050574, it is required to arrange a set of two or event four deflection mirrors, which is complex and cumbersome.

The present invention aims to provide a solution which is simpler, more flexible and smaller in size.

According to a first of its objects, the present invention relates to a personalization module (100), for personalization of a security document (200), said document (200) comprising a marking area for marking a two-image element MLI or CLI through an array (210) of lenticular lenses having a main direction of elongation, said personalization module (100) comprising:
a laser marking module (500), configured to mark within a marking zone, and comprising a laser head (530) configured to emit a laser beam (520), and a laser scanner equipped with movable mirrors to deflect said laser beam (520) towards said document (200).

It is essentially characterized in that it further comprises:
An optical prism (300), configured to refract the laser beam (520) from the laser scanner mirrors to the lenticular lenses, one side of the prism (300) enabling marking a first image element of the MLI or the CLI, the other side of the prism (300) enabling marking a second image element of the MLI or the CLI.

It may further comprise a set of at least one transport mechanism, said set being configured to implement at least one of the following movements:
transport a security document (200) along a Y-axis linear direction, from an entrance to an exit (140) of the desktop personalization module (100), through a marking position (MP),
move the prism (300) at least in a horizontal plane, alongside at least one of the X-axis and the Y-axis.

In one embodiment, the set of at least one transport mechanism is further configured to move the prism (300) at least in a vertical direction.

In one embodiment, the set of at least one transport mechanism is configured to move the prism (300) form a resting position (RP) to a working position (MP), where when viewed from above, the prism (300) is away from the marking zone in the resting position (RP) and over the marking zone in the working position (MP).

In one embodiment, the set of at least one transport mechanism comprises rotating means to rotate the position of the prism (300) in a horizontal plane.

It may be provided at least one motor per movement of the prism (300).

In one embodiment, the prism (300) comprises at least two faces where the laser beam (520) is incident, said faces being coated with anti-reflective coating.

In one embodiment, the prism (300) is isosceles and has a rectangular shaped base which is configured to be parallel to the document (200).

In one embodiment, the prism (300) presents an axis of symmetry which is elongated along a direction which is parallel to the lenticular array (210) main direction of elongation.

In one embodiment, it further comprises a shutter (120).

In one embodiment, the shutter (120) is movable over the document (200) in a plane which is parallel to said document (200), the movement of the shutter possibly being a translation, a rotation or a combination of both a translation and a rotation.

In one embodiment, it further comprises:
an inkjet printing module (400), comprising a moveable printing head being configured to print within a printing zone of the document (200).

In one embodiment, it further comprises a vision system, comprising a camera, aimed at ensuring at least one of the following:
the laser beam positioning;
the document positioning;
the markings position/quality;
the printing.

In one embodiment, it further comprises a chip encoding module, configured to read and to encode a chip comprised within the document (200).

In one embodiment, the prism (300) presents one of the following shapes:
a triangular prism (300);
a right isosceles triangular prism (300) presenting an angle of 90° at its top;
a truncated triangular prism (300);
a 4 faces pyramidal shaped prism (300); and
a 4 faces truncated pyramidal shaped prism (300).

Other features and advantages of the present invention will appear in the detailed description that is given as a mere illustrative and non-limitative example.

Figures are not to scale.

### DRAWINGS

FIG. 1 illustrates a side view of a marking device for a MLI/CLI of a document with a prism according to the present invention,

FIG. 2 illustrates a view of one embodiment of a personalization device comprising a personalisation module according to the present invention,

FIG. 3 illustrates a side view of a marking of a MLI/CLI with a personalization module according to the present invention, with two positions of the scanning mirror,

FIG. 4 illustrates a top view of a marking of a MLI/CLI with a personalization module according to the present invention,

FIG. 5 illustrates a top view of a resting position and a working position of a prism according to the present invention,

FIG. 6 illustrates one embodiment of a prism according to the present invention,

FIG. 7 illustrates a all-in-one personalization device comprising a personalization module according to the present invention,

FIG. 8 illustrates one embodiment of a prism according to the present invention,

FIG. 9 illustrates a side view of a marking of a MLI/CLI with a personalization module according to another embodiment of the present invention, with two positions of the scanning mirror.

For the sake of conciseness, the personalization module according to the present invention will be referred to as “personalization module”. The insertion of a document 200 in the personalization module or in a device comprising the personalization module according to the present invention can be automatic or manual.

It relates to a module for personalization of documents, used in any device or machine, and in particular relates to a stand-alone personalization module or device, including a desktop device where dimension optimisation is of particular interest.

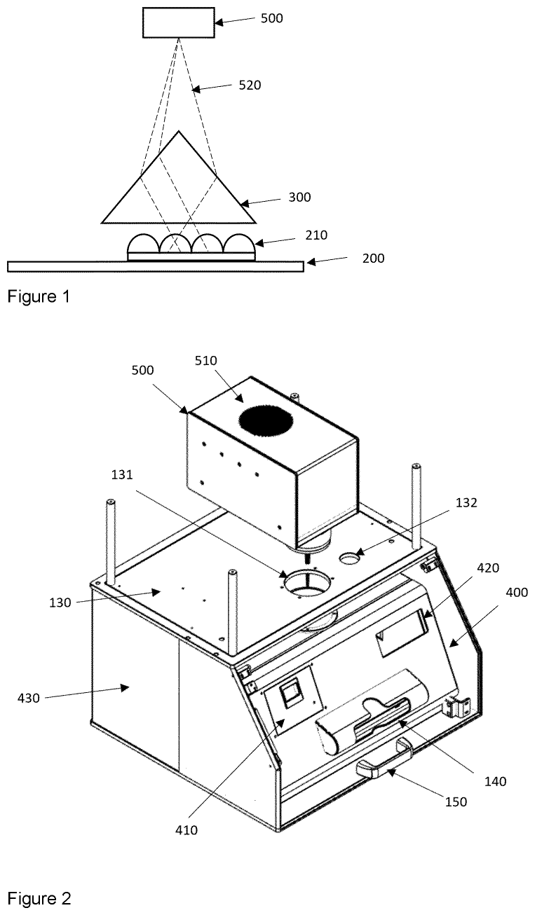

The personalization module 100 may further comprise a casing 110, or be incorporated in an existing casing 430, for instance as illustrated on FIG. 2, wherein the prism is not visible.

The personalization module 100 will be described as if based on a horizontal support, such as e.g. a table or a desktop.

In one embodiment, the document personalization module 100 according to the present invention is configured to be able to operate paper documents and hybrid documents which comprise both paper and polycarbonate pages, such as passports, as well as full polycarbonate documents such as identity cards, driving licenses, etc. within the same module or device.

It offers a wide range of personalization options, preferably all complying e.g. with ICAO 9303 standards. As further described, the personalization module 100 can be integrated as a modular element in a device comprising further personalization elements or modules, securing long-term personalization solution investment, particularly for secure passport issuance offices and centers.

It can be adapted to all types and sizes of documents.

The personalization module 100 comprises a longitudinal axis, here called Y-axis, along which documents are moved as described later.

FIG. 2 illustrates another embodiment of a casing 430 preferably comprising at least one air vent (not illustrated), to vent a laser marking module 500 described here after. The casing 430 also advantageously comprises a fan (not illustrated). The casing 430 may further comprise a set of legs having an adjustable height, to compensate for any lack of horizontality.

All personalization elements of a document 200 which are laser marked are on the same polycarbonate (PC) page. ID cards are usually personalized on both sides as both sides are made of PC.

The personalization module 100 can be integrated in a personalization device such as e.g. illustrated in FIG. 2. On the device of FIG. 2, the prism 300 is not illustrated. It is located inside the inkjet printing module 400, underneath the laser marking module 500. The personalization device of FIG. 2 is preferably a front operated system with manual document 200 insertion and retrieval, or an automated system, thanks to a very precise moving tray of a transport mechanism, aimed at handling the document 200 within the device according to the invention, to ensure high-precision movement for high-quality personalization.

### Laser Marking Module

The personalization module 100 comprises a laser marking module 500 comprising a laser marking head 530.

In operation, on the working position MP, the prism 300 is located above the page of document 200 to be personalized.

The laser marking module 500 can be located above the document 200 to be personalized, as illustrated in FIG. 2, or distant from the page of document 200 to be personalized, as illustrated on FIG. 7.

The laser marking head 530 is configured to mark predetermined areas of a polycarbonate page (and/or certain types of paper) of a passport within a marking zone—or indistinctively area—where, by “marking”, it is understood any of the following processes: marking, engraving, color change/blackening/bleaching, carbonization, ablation.

Typically, the size of the marking zone is inferior or equal to the size of the page of a passport, especially a polycarbonate page.

Predetermined marking areas correspond typically to predetermined identification zones of the document body such as, for instance, the MRZ, portrait of its holder, his or her name, date of birth, a MLI or a CLI etc.

The laser head 530 is stationary.

In one embodiment, the laser head 530 is adjacent to the printing bridge of the optional inkjet printing module 400 described later, such that the marking zone and the printing zone are at least partly combined.

The laser head 530 can be located above the inkjet printing module 400, as illustrated in FIG. 2. In this case, the laser beam 520 from the laser head 530 of the laser marking module 500 can go through an opening 131 made in a horizontal rigid plate 130 of the casing 430 between the laser marking module 500 and the inkjet printing module 400.

The laser marking module 500, which comprises the laser head 530, can mark any of the predetermined areas thanks to a laser scanner, which comprises a set of at least one tiltable mirror 540 and associated driver(s), e.g. piezoelectric driver(s). For this reason, the laser module is indistinctively considered as the laser scanner.

Accordingly, it is possible to mark the MRZ and all personalization data except the MLI/CLI, directly with the laser scanner. MRZ position is defined by ICAO standards. But personalization data can be located anywhere on a document 200. The laser beam 520 can be directed anywhere on the document 200; it is positioned thanks to the mirrors of the laser scanner to mark directly personalization data in corresponding predetermined area(s), meaning with no optical means between the mirrors of the laser scanner and the document 200.

For marking a MLI/CLI, a prism 300 described later is required/needed.

The laser head 530 is configured to perform all types of marking while the tray is positioned under the laser marking module 500 such as:
High definition gray scale picture(s) including ghost image,
Thin high definition text including OCR-B for MRZ, and other fonts & characters used for captions and personalization data,
Barcodes,
Tactile personalization elements,
Thin to bold texts according to specification.

For CLI/MLI elements there is relative movement of the prism 300 and the document 200 such that the prism 300 is located right above the CLI/MLI to be marked in the working position.

Further, the prism 300 may adopt:
a first position relative to the CLI/MLI to be marked on the document 200, to mark the first image element, and
a second position relative to the CLI/MLI to be marked on the document 200, to mark the second image element.

One of the at least three following different laser sources can be implemented:
10W DPSS (Diode-pumped solid-state) laser source,
3W DPSS laser source, and
20W DPSS laser source.
Of course, the present invention is not limited to these laser types.

Other laser sources technologies can be implemented such as e.g. fibre laser sources. Such flexibility provided scalable performance while ensuring the exact same result in terms of marking quality and characteristics.

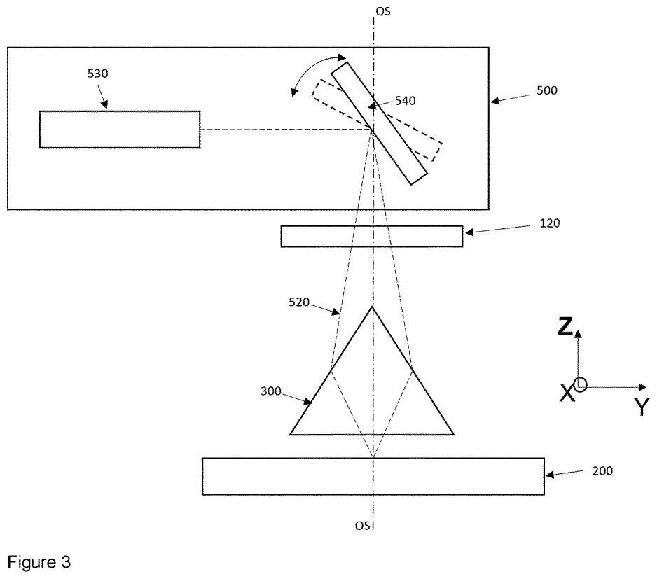

Typically, the laser head 530 emits a laser horizontal beam, parallel to the plane of the document 200. The laser beam 520 from the laser head 530 is directed to tiltable scanning mirrors 540 of the laser scanner, the movement of which allowing to cover the area of the document 200, as illustrated on FIG. 3.

On FIG. 3, scanning mirrors 540 adopt a first position (in plain lines) to mark the first image element of a CLI/MLI; and a second position (in dashed lines) to mark the second image element of a CLI/MLI, such that the laser beam 520 can be diverted to one side or the other of the prism 300.

On FIG. 3, scanning mirrors 540 are located on the axis of symmetry OS of the prism 300.

In another embodiment illustrated on FIG. 9, scanning mirrors 540 are shifted from the axis of symmetry OS of the prism 300.

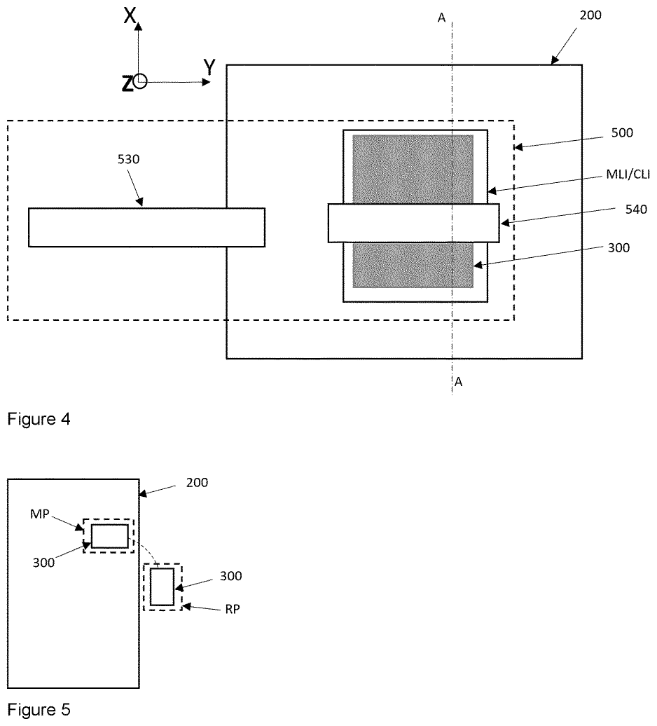

Scanning mirrors 540 are located above the array 210 of cylindrical lenticular lenses, in line with the MLI/CLI to be engraved, as illustrated on FIG. 4.

Preferably, scanning mirrors 540 are plane mirrors. Typically, they can be part of a on-the-shelf laser scanner. They can be tilted at least around a horizontal axis, which is preferably located in line with the middle of the array 210 of cylindrical lenticular lenses.

According to the invention, the laser marking module 500 may be a stand-alone module comprising a casing 110, which can be fixed e.g. with screws to another casing 430, allowing the laser marking module 500 to be secured within the casing 110 but being nonetheless removable in times of need. Accordingly, the laser marking module 500 is interchangeable with another laser marking module 500, for example if there is a need for a more powerful laser.

The laser marking module 500 advantageously comprises a communication module, configured to enable a communication between the laser marking module 500 and a remote computer comprising a display screen. Preferably, the communication module comprises a USB communication port.

Preferably, neither the laser marking module 500 nor the laser marking head can be moved in translation along the Y-axis or the X-axis, which is perpendicular to the Y-axis in a horizontal plane.

The laser marking module 500 may comprise an air vent 510, the position of which preferably corresponding to the position of the air vent of the casing 430.

Where the laser beam 520 can directly mark the MRZ, for marking the MLI/CLI it is necessary to mark a predetermined area through cylindrical lenticular lens of the MLI/CLI. A MLI/CLI comprises 2 image elements: a first image element in contact with a second image element. The first image element of a MLI/CLI is marked with the laser beam 540 having a first angle of incidence on a given cylindrical lenticule and the second image element of the MLI/CLI is marked with the laser beam 540 having a second angle of incidence on said cylindrical lenticule, as illustrated on FIG. 3 or FIG. 9.

To this end, the laser scanner alone is not sufficient, it is necessary to modify the optical path of the laser beam 520.

Contrary to the mentioned prior art which implements reflective means, the present invention advantageously implements here refractive means, in this case an optical prism, here after “prism”, which is described here after.

### Prism

According to the present invention, the personalization module 100 comprises an optical prism 300, here after “prism”.

The prism 300 is isosceles and has a rectangular shaped base which is configured to be parallel to the document 200, which is parallel to the lenticular array 210, as illustrated on FIG. 1.

In one embodiment the prism 300 is a triangular prism 300.

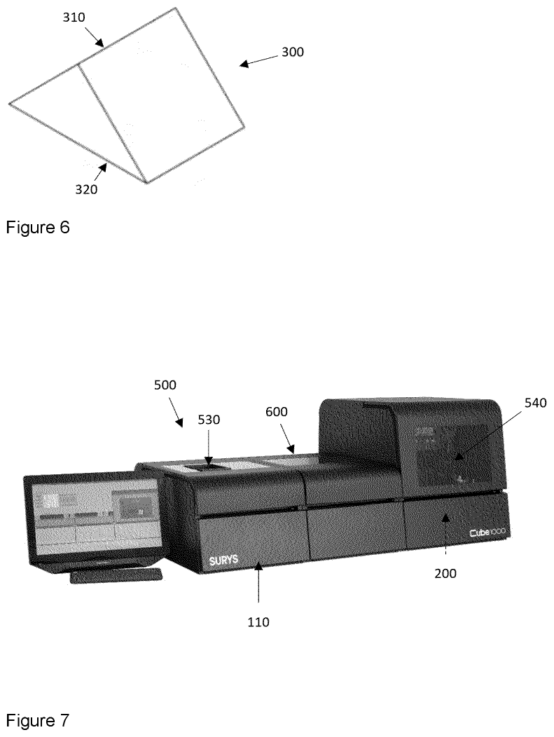

More precisely, in the embodiment illustrated on FIG. 1, FIG. 3 and FIG. 6, the prism 300 is a right isosceles triangular prism 300, presenting an angle of 90° at the top, also called the apex, of the prism 300.

In one embodiment, not illustrated, the prism 300 is a truncated triangular prism.

In one embodiment, not illustrated, the prism 300 is a 4 faces pyramidal shaped prism 300.

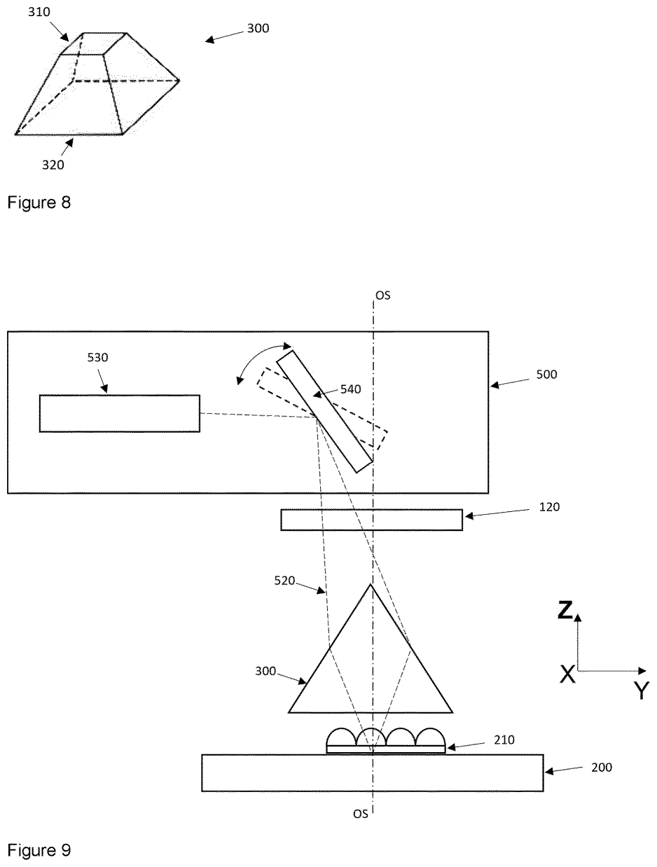

In one embodiment, illustrated on FIG. 8, the prism 300 is a truncated 4 faces pyramidal shaped prism 300, presenting a rectangular shaped base 320 which is parallel to the document 200.

When the prism is truncated, the top of the prism 300 is preferably flat, and preferably parallel to its base. Advantageously, when the prism is truncated, the top of the prism 300 can be used as a surface of contact with a transport means.

Advantageously with a 4 faces pyramidal shaped, even truncated, it is possible to implement the same prism for both a CLI and a MLI without rotating the prism, as 2 opposite faces can be used for marking a CLI and the 2 other opposite faces can be used for marking a MLI.

Preferably, the rectangular shaped base presents a surface which is greater than or equal to the surface of the array 210 of cylindrical lenticular lenses.

It can be provided that the width of the prism 300 is wider than the width of the lenticular array 210.

At its top, the prism 300 has an edge 310 which is preferably located in line with the middle of the lenticular array 210.

Preferably, the edge 310 of the prism 300 is elongated along a direction which is parallel to the lenticular array 210 main direction of elongation.

Preferably, the vertical distance between the edge 310 of the prism 300 and the laser head 530, is less than a predefined threshold.

The distance between the tiltable scanning mirrors 540 of the laser scanner and the prism can be small, e.g. between 10 cm and 20 cm, the personalization module 100 can be particularly compact in size.

Preferably, the vertical distance between the lenticular array 210 and the rectangular shaped base 320, or bottom, of the prism 300 is less than a predefined threshold, in this case less than 20 mm.

Preferably, the prism 300 is movable.

Typically, by default the prism 300 is placed in a resting position RP, away from the MLI zone or the CLI zone, and away from the document 200, in order to protect it from inkjet droplets or any other polluting source. For marking the CLI/MLI of the document 200, the prism 300 is then moved to a working position MP, or marking position, over the MLI zone or the CLI zone.

In one embodiment, the prism 300 is movable over the document 200 in a plane which is parallel to said document 200, alongside at least one of the X-axis and the Y-axis. Accordingly, the position of the prism 300 is adaptable to various sorts of document 200 (for instance a standard passport and a diplomatic passport, etc.), wherever the MLI/CLI is located.

Further, the document 200 may be moved relatively to the prism 300 in a horizontal plane, for instance for even more precise marking of the first image element and the second image element of the CLI/MLI.

In one embodiment, the prism 300 is movable over the document 200 in a vertical direction.

Movements of the prism 300 in a horizontal direction, in a horizontal plane or in the vertical direction can be implemented with help of a respective micro stepper motor, leading to a fine tuning of the position of the prism 300, as low as a tenth of a millimeter.

In one embodiment, the prism 300 can be rotated, in this case over a horizontal direction parallel to the X-axis. The prism 300 can also be rotated with a vertical axis of rotation, as illustrated on FIG. 5. Such rotation can be useful to change from a MLI marking to a CLI marking and also to put the prism in a safe area/rest position when not in use.

It can be provided that two or more of the previous embodiments relating to the movements of the prism 300 are combined.

Thanks to the present invention, a same personalization module 100 can be implemented for a first type of document 200 comprising a CLI and a second type of document 200 comprising a MLI, for instance a passport and ID card.

Rotating the prism 300 allows the same prism 300 to be used for both CLI and MLI (generally lenticules main direction for CLI is perpendicular to lenticular grating main direction for MLI).

It can also be provided that the personalization module 100 comprises two prisms 300, a first prism 300 configured to engrave a MLI, and a second prism 300 configured to engrave a CLI.

In one embodiment, at least the two faces of the prism 300 adjacent to the base 320 are coated with anti-reflective coating, leading to almost no reflection of the laser beam 520.

In operation, the laser beam 520 is deflected by the mirrors of the laser scanner on one side of the prism 300 or on the opposite side of the prism 300 to mark respectively a first image element and a second image element of the MLI/CLI, as illustrated on FIG. 1 and FIG. 3.

Thanks to the present invention, there is no need to tilt the document 200 to mark the MLI/CLI area. Further, there is no need for mirrors dedicated to engraving a tilt image.

Accordingly, there is a full flexibility in positioning of the MLI/CLI on a document 200.

The present invention allows different tilt image positions in the same personalization module 100, configurable with the layout.

A same personalization module 100 can mark both CLIs and MLIs of different documents with a same device.

Compared with a set of several mirrors of the mentioned prior art, the present invention relies advantageously on a prism 300, which is a unique, one-piece, element. Accordingly, only one unique optical system is enough to ensure the setting of two engraving directions of the laser beam 520.

Further, as the prism 300 presents a plane base parallel to the plane of the document 200, the prism can be nearer to the document than the mirrors of the prior art, leading to a compact device.

The laser beam is refracted by the lateral faces of the prism 300. In one embodiment it can be incident on the prism at an angle equal to the Brewster angle so that all the light is refracted. Accordingly, there is no reflection, which optimises the energy.

In one embodiment, the prism 300 has the following geometrical dimensions: angle of 90° at its top, angles of 45° between the sides and the base.

### Shutter

The personalization module 100 can comprise a shutter 120.

In one embodiment, the shutter 120 is movable over the document 200 in a plane which is parallel to said document 200, alongside at least one of the X-axis and the Y-axis.

Movements of the shutter 120 can be implemented with help of a micro stepper motor, a standard motor or an actuator, as the need for a fine tuning of the position of the shutter 120 is not as strong as the need for a fine tuning of the position of the prism 300.

In one embodiment, the shutter 120 can be rotated, or flipped over a horizontal direction parallel to the X-axis, like a flap. The shutter 120 can also be rotated over a vertical direction.

The movement of the shutter 120 may be combined with the movement of the prism 300.

In one embodiment, when the prism 300 is in its resting position RP, the shutter 120 is closed and protects the prism 300, especially from dust and form ink droplets when the personalization module 100 further comprises an inkjet printing module 400, described hereafter.

### Inkjet Printing Module

In one embodiment, illustrated on FIG. 2, the personalization module 100 comprises an inkjet printing module 400, which comprises a moveable printing head mounted on a fixed printing bridge. The printing head is movable alongside the X-axis linear direction.

The printing head can adopt at least the 3 following positions:
A printing position, where the printing head is configured to print within a printing zone,
A printhead purge position, where the printing head can be purged, and
A parking position, where the printing head can be parked, and where the inkjet cartridges are located.

The printing operation is implemented with a plurality of printing positions as a tray supporting the document 200 moves along the Y-axis linear direction during the printing operation.

Preferably, the printing head is connected to color and black inkjet cartridges. It is configured to print on any or both of page 2 and page 3 of a document 200. Said colors can be within the visible spectrum, the UV spectrum, the IR spectrum, or any combination thereof. Inkjet cartridges are accessible through an access 410.

The printing head is configured to print within predetermined printing areas of any paper page, and optionally in addition on a polycarbonate page, of a document 200 within a printing zone. Typically, the size of the printing zone is inferior or equal to the size of the paper page of a document 200.

Predetermined printing areas correspond typically to predetermined identification zones of the document 200 holder such as, for instance, the MRZ, his or her portrait, his or her name, date of birth, etc.

The inkjet printing module 400 comprises a substantially flat horizontal surface on which a transport mechanism, the printing bridge and a flattening mechanism, are mounted.

In one embodiment, the inkjet printing module 400 is based on an existing printer, such as the Hiprint™ P4000, produced by the applicant, which comprises a flattening mechanism; and from which the top of the casing 430 is removed. For those starting with ‘paper only’ booklet and upgrading to ‘paper and polycarbonate’ at a later stage, it is possible that such Hiprint™ P4000 printer can be reused within the proposed personalization module 100, allows transitioning from paper document 200 to polycarbonate document 200 with a smooth investment. Such printer offers high quality printing (up to 4800 dpi) for paper booklets personalization. It does include a 4-color inkjet printing head, which can easily be hot swapped by an operator.

Advantageously, the transport mechanism of the personalization module 100 is the transport mechanism of the inkjet printing module 400, which can be an existing inkjet printer as exposed above. Accordingly, the inkjet printing module 400 comprises the document 200 transport mechanism.

In one embodiment, a transport mechanism is configured to automatically transport a document 200 along a Y-axis linear direction, from an entrance to an exit 140 of the personalization module 100, wherein the entrance and the exit 140 are the same. The personalization module 100 is then a front-operated manual feeder, for both document 200 insertion and retrieval.

In one embodiment, a transport mechanism comprises a tray on which the document 200 is placed for marking/printing. The tray may be moved along guide bars, which is a high precision mechanism know in itself allowing highly precise positioning of the tray.

Preferably, the tray is provided with secure handle, ensuring proper document 200 positioning.

In one embodiment, a transport mechanism comprises a set of at least one clamp to clamp the document 200 open for printing and marking.

In one embodiment, a transport mechanism is configured to transport the document 200 to the printing position and to a marking position, which is different from the printing position.

In one embodiment, a document 200 transport mechanism is configured to transport a document 200 to the printing positions and the marking position with the document 200 having its spine parallel to the X-axis linear direction, typically when the document 200 is a passport.

Embodiments may be combined.

The inkjet printing module 400 is accessible through a flap within the casing 430, preferably equipped with a handle 150. The opening of the flap, e.g. via a handle, enables access to the inkjet printing module 400, e.g. for its repair or replacement. Accordingly, the personalization module 100 is modular. The size of the flap is bigger than the size of the inkjet printing module 400.

Preferably, for safety reasons, the opening of the flap shuts off the power to the laser marking head, for instance with a sensor acting as a circuit breaker.

In one embodiment the flap further comprises a manual hatch (not illustrated), the size of which being bigger than the size of a document 200, to enable manual insertion of a document 200 in the inkjet printing module 400 through that flap.

Preferably, the opening of the hatch shuts off the power to the laser marking head. Opening the hatch allows the operator to insert a document 200 without having to open the flap. In such a case, the flap can be open just for maintenance reasons, such as e.g. change of the inkjet cartridges. The hatch allows an operator to insert and retrieve a document 200 with just a movement of his hands, which is better in terms of ergonomics than manipulating the flap, which requires an additional movement of the shoulder.

According to the invention, the inkjet printing module 400 is a stand-alone module fixed within the casing 430, e.g. with screws, allowing the inkjet printing module 400 to be secured within the casing 430 but being nonetheless removable in times of need. Accordingly, the inkjet printing module 400 is interchangeable with another inkjet printing module 400.

The inkjet printing module 400 comprises a communication module, configured to enable a communication between the inkjet printing module 400 and a remote computer comprising a display screen.

Preferably, the inkjet printing module 400 may comprise a display screen 420, e.g. a LCD screen, which is driven by the mother card of the inkjet printing module 400, and which allows to display maintenance information, like e.g. the level of ink left.

### Vision & Detection Systems

The personalization module 100 may comprise a vision system, comprising a camera, aimed at ensuring personal data positioning (offset registration).

In addition, it can as well ensure element detection (i.e. OCR) and automated quality control at the end of the personalization process.

The vision system may be used for several purpose:
Document 200 proper introduction and orientation verification (specific element detection),
Document 200 ID retrieval,
Printing/marking image repositioning (offset positioning) to ensure a perfect printing zone position,
Page 2 and/or page 3 graphical area snapshot for post-personalization quality control, data consistency check, and personalization characteristics verification,
Page 2 and/or page 3 snapshot to store document 200 final image into a database.

The camera is particularly configured to detect the position of the document 200 once positioned on a transport mechanism. It is also configured to drive at least one of the inkjet printing module 400 and the laser marking module 500 according to a comparison of said position with a reference position.

The camera can detect the position of the document 200, i.e. which of page 2 and page 3 enters first. If the position of the document 200 is improper, a warning message can be triggered, a transport mechanism can be automatically reversed to eject the document 200, or any other suitable operation.

Preferably, the personalization module 100 further comprises a detection system, e.g. a presence sensor, typically an optical sensor such as a photocell, or any other detection mechanism to detect the entrance of a document 200 into the personalization module 100 or into a transport mechanism.

Preferably, the camera is close to the laser marking head, where “close” means at a distance inferior to a predetermined value. It is worth noting that several cameras may be provided, e.g. one for the offset registration and one for the document 200 position detection.

Preferably, the angle between the optical axis of the camera for the offset registration and the laser beam 520 of the laser marking head is inferior or equal to a predetermined value, here inferior or equal to 10°.

The vision system comprises a communication module, configured to enable a communication between the camera and a remote computer comprising a display screen. Preferably, the communication module comprises a USB communication port.

In one embodiment, a camera of the vision system is located in the casing 430 above the inkjet printing module 400, adjacent to the laser marking module 500. The optical axis of the camera goes through an opening 132 made in the horizontal rigid plate, adjacent to the opening 131, as illustrated on FIG. 2.

### Chip Encoding Module

The personalization module 100 may comprise a chip encoding module 600 (FIG. 7), configured to read and to encode a chip comprised within the document 200, especially when the document 200 is a passport.

Typically, the chip is a RFID chip, thus the chip encoding module is an RFID encoding module comprising a RFID antenna. More precisely, the RFID module is based on a set including reader electronics and a separate antenna preferably complying with ICAO 9303 requirements.

In one embodiment, the chip encoding module is comprised in the inkjet printing module 400.

In one embodiment, the RFID antenna is located under the tray of the transport mechanism. Thanks to the antenna position, once the booklet is inserted in the personalization module 100, it is possible to establish a communication with the chip, and therefore to start encoding whatever the other operations in progress are. Typically, it is possible to encode while printing and/or marking, which allows significant time saving during the entire personalization process.

Advantageously, the chip encoding module is integral with the document 200 transport mechanism. Accordingly, the chip of the document 200 can be encoded while the document 200 is being transported from a position to another, both reducing the time of personalization and compacting the personalization module 100. This allows parallel encoding while printing, speeding-up the whole personalization process for more production throughput and efficiency.

In one embodiment, the personalization module 100 is a stand-alone desktop personalization device.

The chip encoding module 600 comprises a communication module, configured to enable a communication between said chip encoding module and a remote computer comprising a display screen, as illustrated on FIG. 7.

Preferably, the communication module of the chip encoding module is the same than the communication module of the inkjet printing module 400.

One only communication module can be provided for the vision system, the laser marking module 500, the inkjet printing module 400 and the chip encoding module.

### NOMENCLATURE

100 personalization module
110 Casing of the personalization module
120 Shutter
130 Horizontal rigid plate
131 opening (for the laser head 530)
132 opening (for a camera)
140 entrance and exit of the personalization module
150 handle
200 Document 200
210 Array of lenticular lenses
A-A Lenticular array main direction of elongation
300 Optical prism
310 Edge/top/apex of the prism
320 Base of the prism
RP Resting position
MP Working/Marking position
OS optical axis of symmetry of the prism 300
400 Inkjet printing module
410 Access to inkjet cartridges
420 Display screen
430 casing of the inkjet printing module
500 Laser marking module
510 air vent
520 Laser beam
530 laser head
540 scanning mirror(s), for two-axis driving of the laser beam
600 chip encoding module

1. A personalization module, for personalization of a security document, said document comprising a marking area for marking a two-image element MLI or CLI through an array of lenticular lenses having a main direction of elongation, said personalization module comprising:
a laser marking module, configured to mark within a marking zone, and comprising a laser head configured to emit a laser beam, and a laser scanner equipped with movable mirrors to deflect said laser beam towards said document,
wherein the personalization module further comprises:
an optical prism, configured to refract the laser beam from the laser scanner mirrors to the lenticular lenses, one side of the prism enabling marking a first image element of the MLI or the CLI, the other side of the prism enabling marking a second image element of the MLI or the CLI.

2. The personalization module according to claim 1, further comprising a set of at least one transport mechanism, said set being configured to implement at least one of the following movements:
transport a security document along a Y-axis linear direction, from an entrance to an exit of the desktop personalization module, through a marking position (MP),
move the prism at least in a horizontal plane, alongside at least one of the X-axis and the Y-axis.

3. The personalization module according to claim 2, wherein the set of at least one transport mechanism is further configured to move the prism at least in a vertical direction.

4. The personalization module according to claim 2, wherein the set of at least one transport mechanism is configured to move the prism form a resting position (RP) to a working position (MP), where when viewed from above, the prism is away from the marking zone in the resting position (RP) and over the marking zone in the working position (MP).

5. The personalization module according to claim 2, wherein the set of at least one transport mechanism comprises rotating means to rotate the position of the prism in a horizontal plane.

6. The personalization module according to claim 2, comprising at least one motor per movement of the prism.

7. The personalization module according to claim 1, wherein the prism comprises at least two faces where the laser beam is incident, said faces being coated with anti-reflective coating.

8. The personalization module according to claim 1, wherein the prism is isosceles and has a rectangular shaped base which is configured to be parallel to the document.

9. The personalization module according to claim 8, wherein the prism presents an axis of symmetry which is elongated along a direction which is parallel to the lenticular array main direction of elongation.

10. The personalization module according to claim 1, further comprising a shutter.

11. The personalization module according to claim 10, wherein the shutter is movable over the document in a plane which is parallel to said document, the movement of the shutter possibly being a translation, a rotation or a combination of both a translation and a rotation.

12. The personalization module according to claim 1, further comprising:
an inkjet printing module, comprising a moveable printing head being configured to print within a printing zone of the document.

13. The personalization module according to claim 1, further comprising a vision system, comprising a camera, aimed at ensuring at least one of the following:
the laser beam positioning;
the document positioning;
the markings position/quality;
the printing.

14. The personalization module according to claim 1, further comprising a chip encoding module, configured to read and to encode a chip comprised within the document.

15. The personalization module according to claim 8, wherein the prism presents one of the following shapes:
a triangular prism;
a right isosceles triangular prism presenting an angle of 90° at its top;
a truncated triangular prism;
a 4 faces pyramidal shaped prism; and
a 4 faces truncated pyramidal shaped prism.
